(19) United States
(12) Patent Application Publication
(10) Pub. No.: US 2022/0158397 A1
(43) Pub. Date: May 19, 2022

(54) ELECTRIC MOTOR HAVING A COMMUTATOR AND BRUSH FOR THE ELECTRIC MOTOR

(71) Applicant: Brose Fahrzeugteile SE & Co. Kommanditgesellschaft, Bamberg, Bamberg (DE)

(72) Inventors: Helmut Pfalzgraf, Eibelstadt (DE); Christian Saum, Grosslangheim (DE)

(21) Appl. No.: 17/526,146

(22) Filed: Nov. 15, 2021

(30) Foreign Application Priority Data
Nov. 13, 2020 (DE) 10 2020 214 322.6

(51) Int. Cl. H01R 39/26; H02K 13/10

(52) U.S. Cl. CPC H01R 39/26; H02K 13/10

(57) ABSTRACT

An electric motor has a commutator and at least one brush with a concavely curved brush surface as a running surface for the commutator. The brush has two parallel running in ribs, which protrude perpendicularly above the brush surface. The running in ribs each have a radius of curvature which is greater than a radius of curvature of a convex commutator surface. The running in ribs are arranged eccentrically and at a spacing from one another such that they are offset with respect to two opposing surface outer edges of the brush surface. The running in ribs are arranged such that they are inclined at an angle of inclination with respect to the surface outer edges.

### CROSS-REFERENCE TO RELATED APPLICATION

This application claims the priority, under 35 U.S.C. § 119, of German Patent Application DE 10 2020 214 322.6, filed Nov. 13, 2020; the prior application is herewith incorporated by reference in its entirety.

### FIELD AND BACKGROUND OF THE INVENTION

The invention relates to an electric motor, which has at least one, in particular spring-loaded, brush for bearing against a commutator. The invention furthermore relates to a brush for such an electric motor.

Motor vehicles today normally have a number of adjustment parts, for example a seat adjustment mechanism, an actuable lock, a window winder and/or an adjustable sunroof, which can be displaced between different adjustment positions by use of a respectively associated electric motor as an adjustment drive.

Deviating from a brushless electric motor, in an electric motor equipped with a commutator fixed to the shaft, normally two, or even more, brushes sweep over a number of commutator segments, which transmit the electric current to the windings of a rotor rotating with the motor shaft. By means of the segments, a reversal of current (commutation) is generated from winding to winding, which generates a torque on the motor shaft (rotor shaft) with respect to normally fixed magnetic poles of the stator.

When the electrical contacting of the brushes switches over to the next commutator segment in the direction of rotation in each case, the brush is positioned on two commutator segments and therefore short circuits the winding. Consequently, at this point in time, the electric current (motor current, armature current) flowing through the electric motor is increased. This continues until the brushes, owing to the rotation of the commutator or rotor, are again only electrically contacted by one of the commutator segments in each case. This periodic increase and reduction in the resistance impresses an alternating current component on the motor current. In this case, this alternating current component, also referred to “as current ripple” or “ripple current” (ripple signal), is often used for sensorless determination of a rotation value, in particular such as the rotor position or the rotor speed of the rotor, or is used for sensorless position determination of an adjustment part driven by the electric motor.

The brushes are conventionally cuboidal rods pressed from carbon powder—possibly together with metal particles. Owing to the sliding contact with the commutator segments, the brushes are subject to abrasion during the operation of the electric motor. In order to maintain the contact between the brush and the commutator in spite of the abrasion, the brushes are generally mounted in a tubular brush shaft (tubular brush holder) such that they are displaceable by means of mechanical springs under the action of their spring force, so that automatic readjustment of the brushes takes place.

To prevent noise generation during operation of the motor, a running in and bedding in radius of the brush surface is provided which is greater than the radius of curvature of the commutator. In order to ensure an electrically and mechanically reliable sliding contact, it is necessary for a radius of curvature of the concave running surface to be adapted as precisely as possible to the radius of curvature of the convex commutator surface. In the case of new brushes, this is generally realized by means of a so-called bedding in or running in procedure, in which the brush surface is adapted to the commutator surface through abrasion.

In particular, in the initial operation, i.e. during the first operation of the electric motor, before the brushes are bedded in, tolerances in the brush guide and/or the force direction of the (brush) springs during the change in the direction of rotation of the commutator result in deformed or distorted ripple signals since the contact surface between the brushes and the commutator segments is reduced in the event of a tilting of the brushes. This hinders the sensorless determination of the rotation value or the position.

End face geometries of the brush surfaces can be conceived, for example, to improve the ripple signals during the bedding in or running in process. By way of example, published, non-prosecuted German patent application DE 10 2008 004 138 A1 discloses a running in contour of the brush, in which preferably three running in ribs are arranged centrally on the brush surface, which running in ribs are arranged such that they are inclined at an angle with respect to a main axis of the brush surface. In this case, the running in ribs are arranged adjacent to one another and have a radius which is greater than the commutator radius.

### SUMMARY OF THE INVENTION

The invention is based on the object of providing a particularly suitable electric motor. In particular, the signal quality of a ripple single during a bedding in procedure of a brush should be improved. The invention is furthermore based on the object of providing a brush which is suitable for this.

With regard to the electric motor, the object is achieved according to the invention by the features of the independent electric motor claim and, with regard to the brush, by the features of the independent brush claim. Advantageous configurations and developments are the subject matter of the subclaims. The advantages and configurations mentioned with regard to the electric motor are essentially also applicable to the brush and vice versa.

The inventive electric motor is, in particular, provided as an adjustment drive for a motor vehicle, and is designed and suitable for this. To this end, the electric motor has a commutator which is rotatable about a motor axis. The commutator has a number of commutator segments over which at least one brush sweeps in the assembled state. In this case, the brush has a brush head which faces the commutator and has a concavely curved brush surface as a brush contact surface or running surface.

In this case, a concavely curved brush surface is understood to be an inwardly arched surface. In this case, a surface of a body is concave if a straight line between any selectable points of this surface extends completely outside the body. In this case, other regions of the surface can be disregarded.

Details relating to the spatial directions are, in particular, also indicated below in a coordinate system of the electric motor. Here and below, “axially” or an “axial direction” is, in particular, understood to be a direction which is parallel (coaxial) to the motor axis of the electric motor, i.e. perpendicular to the end faces of the commutator. Accordingly, here and below, “radially” or a “radial direction” is, in particular, understood to be a direction along a radius of the commutator or the electric motor which is orientated perpendicularly (transversely) to the motor axis of the electric motor. Here and below, “tangentially” or a “tangential direction” is, in particular, understood to be a direction along the circumference of the commutator or the electric motor (circumferential direction, azimuthal direction), i.e. a direction which is perpendicular to the axial direction and to the radial direction.

In this case, the brush surface has two main axes along the axial direction and the tangential direction. In this case, the brush surface is, in particular, a tangentially curved surface, which extends in the axial direction. In this case, the width of the brush surface extends in the tangential direction, wherein the height of the brush surface is orientated in the axial direction.

Precisely two parallel running in ribs are formed on the brush in one piece, i.e. integrally or monolithically, which ribs jut perpendicularly from the brush surface in the radial direction, i.e. in the direction of the commutator or the commutator segments. Forming a gap with respect to the commutator, at least on the running in side, the radius of curvature or bedding in radius of the brush surface is, for example, greater than the radius of curvature of the cylindrical, convexly curved commutator surface (commutator radius), which corresponds to a commutator contact surface or commutator running surface.

In this case, a convexly curved commutator surface is understood to be an outwardly arched surface. In this case, a surface of a body is convex if a straight line between any selectable points of this surface extends completely within the body. In this case, other regions of the surface can be disregarded.

The radially raised running in ribs are arranged eccentrically and at an axial spacing from one another on the brush surface. In this case, the running in ribs are arranged such that they are offset with respect to the axially opposing surface outer edges of the brush surface, wherein the running in ribs do not, however, extend beyond these surface outer edges. This means that the running in ribs are arranged as far apart as possible. In other words, the greatest possible (axial) clearance is formed between the running in ribs.

According to the invention, the approximately linear running in ribs are arranged such that they are inclined at an angle of inclination with respect to the surface outer edges or main axes of the brush surface. In other words, the running in ribs extend in a sloping or tilted manner on the brush surface. The running in ribs therefore have, in particular, both a tangential and an axial component. A particularly suitable electric motor is thus realized.

The invention therefore starts with the idea of optimizing the ripple signal during the intended motor operation in the new state of the brush solely through the design of the brush contact surface. During the interaction with the commutator, automatic alignment of the brush is brought about as a result of the inclined running in ribs, whereby a suitable ripple signal can also be generated in the non-bedded-in state. This means that, as a result of the running in ribs, the ripple signal is optimized at the start of the operating time and also upon a change in the direction of rotation.

Since, to prevent noise generation, a running in and bedding in radius should be present which is greater than the radius of curvature of the commutator, the running in ribs provided should be as narrow as possible—as seen in the axial direction—so that bedding in is thus performed in a correspondingly short operating time.

In this case, “running in” or “bedding in” of the brush is, in particular, understood to be an approximation of the radius of curvature on the brush side to the radius of curvature on the commutator side in the course of—i.e. during—an automatic bedding-in process of the brush during the first operation of the electric motor. In this case, brush material of the brush, which consists of an electrically conductive material, in particular pressed carbon in dust or particle form, is worn away owing to its sliding contact with the commutator or its commutator segments. The bedding in process, and therefore the running in process, is terminated when the radii of curvature of the concave brush contact surface and the convex commutator surface are practically the same and the contacting arcuate surface of the brush is therefore adapted to the cylindrical contact surface of the commutator. In the bedded in or run in state, the running in ribs are worn away substantially completely.

The radius of curvature of the brush and/or the bedding in radius should only be marginally greater than that of the commutator so that a tilted motion of the brush with respect to the opening slot opposite the commutator cannot occur in the new state of the brush, and the axial edges of the mutually spaced commutator segments do not collide with the brush. In this case, the bedding in radius of the running in ribs is substantially derived from the sum of the commutator radius and tilt tolerance compensation.

In a suitable embodiment, the running in ribs extend substantially over the entire tangential width of the brush surface. It is thus ensured that reliable bedding in with a good ripple signal is also enabled upon a change in the direction of rotation or a reversal of the direction of rotation of the electric motor or commutator.

The angle of inclination of the running in ribs can be varied with regard to the mechanical stability of the running in ribs, i.e. with regard to whether the brush material is friable or crumbly, and/or with regard to the handling and main dimension of the brush. Nick-induced discontinuities in the brush surface or ripple signals are thus prevented. In an expedient configuration, the running in ribs are arranged such that they are inclined at an acute angle of inclination with respect to the tangential direction. This means that the angle of inclination is an acute angle of less than 45°. In an advantageous development, the angle of inclination is dimensioned such that it is in an angular range between 2° and 10°, in particular between 4° and 6°. The angle of inclination is preferably approximately 5°, i.e. 4.5° to 5.5°, for example. In this case, the angle of inclination can be positive, so that the running in ribs extend axially from bottom to top over the brush width, or negative, so that the running in ribs extend axially from top to bottom over the brush width.

In a possible design, the running in ribs have, for example, a triangular cross-sectional form in a radial and axial sectional plane. In this case, a point or corner facing the commutator forms the bearing or contact surface with respect to the commutator segments, whereby a punctiform or linear contact is realized. In this case, the running in ribs or the triangle edges are arranged to be as steep as possible so that a reduction in rib material is realized.

The inventive brush is configured, in particular, as a carbon brush and is provided for an electric motor described above and is configured and suitable for this. In this case, the brush has a concavely curved brush surface with two protruding and mutually parallel running in ribs. In this case, the protruding running in ribs are arranged eccentrically and at a spacing from one another such that they are offset with respect to two opposing surface outer edges of the brush surface and inclined at an angle of inclination with respect to the surface outer edges. A particularly suitable brush for an electric motor is thus realized. In particular, a brush is therefore realized which enables a reliable and optimized ripple signal in the course of a bedding in or running in process during the first operation.

Other features which are considered as characteristic for the invention are set forth in the appended claims.

Although the invention is illustrated and described herein as embodied in an electric motor having a commutator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic illustration of a brush system of an electric motor with two brushes, which are each supported against a commutator in a tubular holder via a brush pressure spring, according to the invention;

FIG. 2 is a perspective view of the brush, looking onto a brush surface of the brush which is directed towards the commutator, with two mutually spaced, radially raised running in ribs in the non-bedded-in new state of the brush;

FIG. 3 is a front view of the brush, looking onto the brush surface;

FIG. 4 is a sectional view of the brush taken along the section line IV-IV shown in FIG. 3;

FIG. 5 is a plan view of the brush;

FIG. 6 is an illustration of a detail of the brush in a corner region VI shown in FIG. 3 in a front view; and

FIG. 7 is a sectional view of the brush taken along the section line VII-VII shown in FIG. 3.

### DETAILED DESCRIPTION OF THE INVENTION

Mutually corresponding parts are always denoted by the same reference signs in all figures.

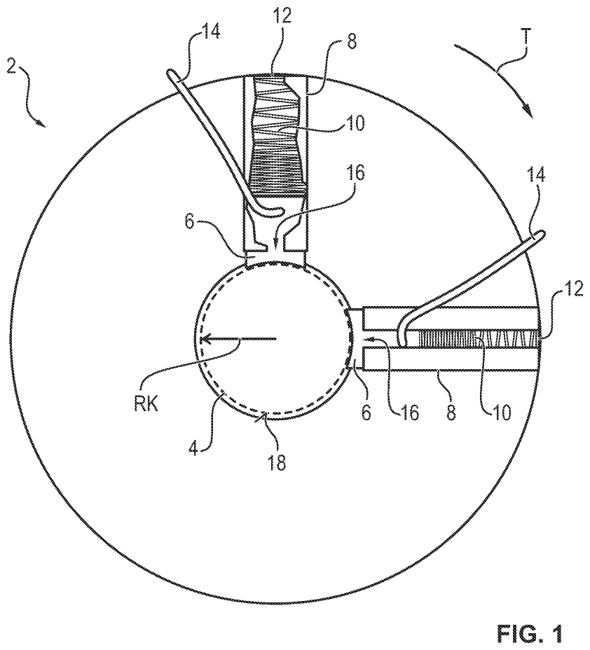

A detail of an electric motor 2, or the commutator and brush system thereof, is illustrated in FIG. 1. In this case, the brush system, which is not shown in more detail, is configured in the form of an annular disk and is arranged eccentrically around a commutator 4 of the electric motor 2. The brush system contains two (carbon) brushes 6, which are in contact with the commutator 4. The commutator and brush system furthermore contains two tubular (brush) holders 8 as a brush shaft or brush holder in which the brushes 6 are guided radially with respect to the commutator 4 and perpendicularly to one another.

Here and below, “axially” or an “axial direction A” is, in particular, understood to be a direction which is parallel (coaxial) to the motor axis of the electric motor 2, i.e. perpendicular to the end faces of the commutator 4. Accordingly, here and below, “radially” or a “radial direction R” is, in particular, understood to be a direction along a radius RK of the commutator 4 which is orientated perpendicularly (transversely) to the motor axis of the electric motor 2. Here and below, “tangentially” or a “tangential direction T” is, in particular, understood to be a direction along the circumference of the commutator 4 or the electric motor 2 (circumferential direction, azimuthal direction), i.e. a direction which is perpendicular to the axial direction A and to the radial direction R.

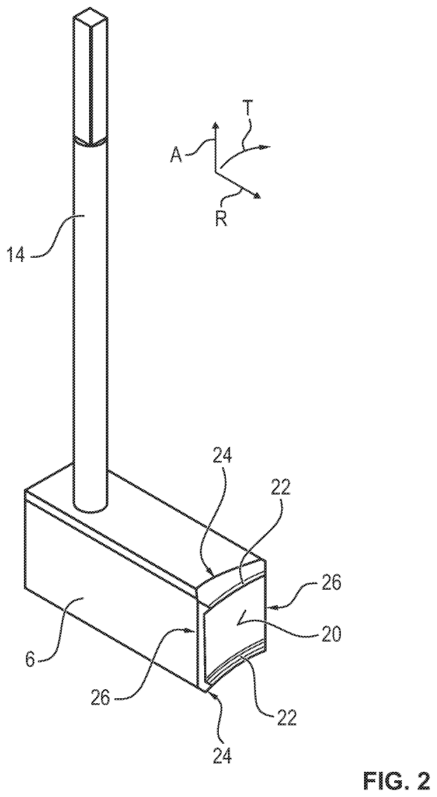

To generate a drive force between the brushes 6 and the commutator 4, the commutator and brush system moreover contains two brush pressure springs 10, which each lie in one of the tubular holders 8, between the brushes 6 and a radially outer tubular-holder base 12. For clarification, one of the tubular holders 8 is illustrated broken away in FIG. 2.

In the electric motor 2, the brushes 6 serve for the transmission of current to the commutator 4 rotating during operation of the electric motor 2 and therefore to the windings (not illustrated in more detail) of the rotor of the electric motor 2. For the transmission of current, the brushes 6 have a respective connection cable 14 on their upper lateral surfaces. For simple contacting of the brushes 6, the connection cable 14 leads out of a longitudinal slot 16 extending in the tubular holder 8 in each case.

The commutator 4 has a number of commutator segments (not shown in more detail) on its outer circumferential side, which commutator segments extend in the axial direction A, and therefore parallel to the motor axis (not shown in more detail) extending perpendicularly into the plane of the drawing, and are arranged such that they are distributed with respect to one another on the circumferential side to form axial gaps filled, for example, with an insulating material. On the commutator side, the commutator segments form a contact surface (referred to below as commutated surface 18) with the respective brush 6, wherein the commutator surface 18 is convexly curved owing to the cylindrical form of the commutator 4. In this case, the radius of curvature of the commutator surface 18 on the commutator side corresponds to the commutator radius RK.

The end face of the brush 6, which faces the commutator 4, is also referred to below as the brush head, wherein the brush head is provided with a concave head recess which has a brush surface 20 as a contact surface or running surface.

The construction of the brush is explained in more detail below with reference to FIGS. 2 to 7.

In this case, FIGS. 2 to 7 show a new state of the brush 6. It can be seen that the brush 6 has two running in ribs 22, which are raised in the radial direction R, i.e. they project from the remaining contact regions of the brush contact surface 20 in the direction of the commutator 4. These running in ribs are spaced from one another in the axial direction A in such a way that as large a spacing as possible is formed between the two running in ribs 22. In this case, the running in ribs 22 are each arranged on an azimuthal or tangential surface outer edge 24 of the brush 6 so that a contact region of the brush 6 is formed between the running in ribs 22 which corresponds substantially to the brush surface.

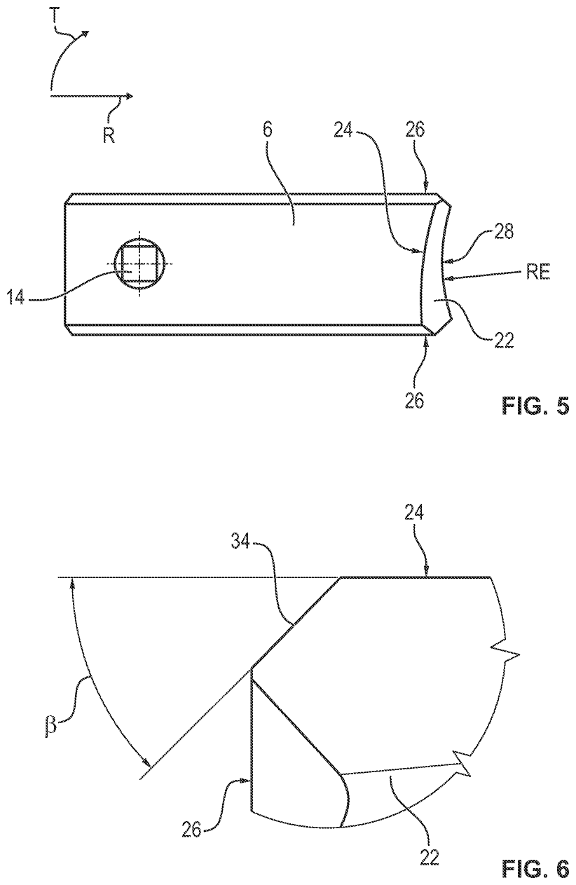

The running in ribs 22 extend completely between the two axially extending surface outer edges 26 of the concave brush surface 26. In the new state, when the electric motor 2 is fully assembled, the running in ribs bear against the commutator 4, or against its commutator segments, and therefore against the convex commutator surface 18, merely with contact points 28 (FIG. 5) in the middle or center.

The radially protruding running in ribs 22 each have a radius of curvature RE (FIG. 5), also referred to as a running in or bedding in radius, which is greater than the radius of curvature RK of the commutator surface 18.

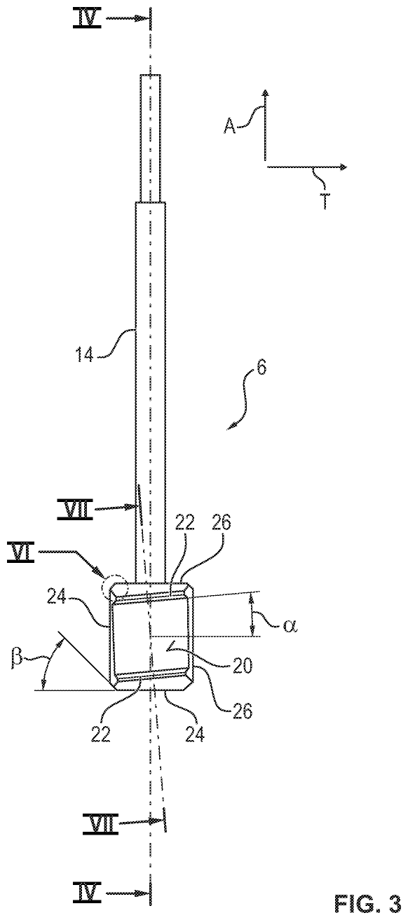

As can be seen in particular in FIG. 3, the approximately linear running in ribs 22 extend substantially over the entire tangential width of the brush surface 20. In this case, the running in ribs 22 extend at an angle of inclination α with respect to the tangential direction T of the brush surface 20. The angle of inclination α is, for example, 5°.

The connection cable 14 and the brush 6 are connected to one another via a stamped contact, for example. In this case, a cable end 30 of the connection cable 14 on the brush side is inserted into the conductive powder of the brush 6 and the powder is subsequently hardened to form the brush 6. The connection cable 14 is configured as a braided power cable (mesh braid), for example, and has a stranded end as a connection region at the cable end 32 opposite the cable end 30.

The end-face corner regions of the brush head are each provided with an edge chamfer 34 (shown in more detail in FIG. 6). The edge chamfer 34 has a chamfer angle β of 45°±5°, for example.

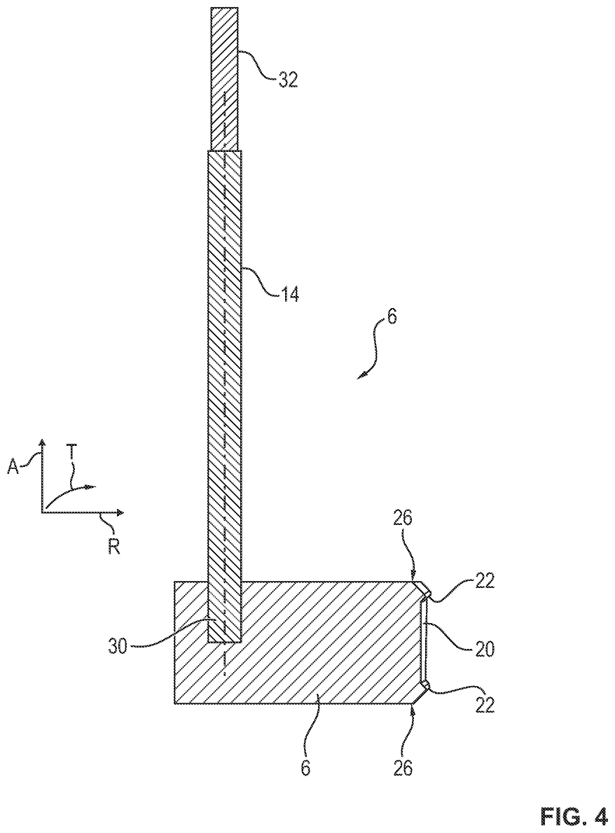

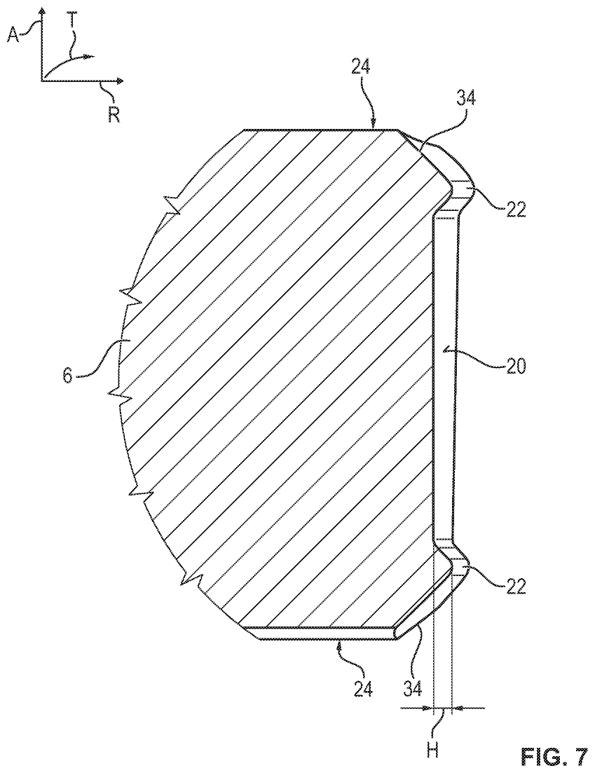

A can be seen by way of example in FIG. 4 and FIG. 7, the running in ribs 22 have a substantially triangular cross-sectional form. In particular, the running in ribs 22 have a cross-sectional form in the form of a right-angled triangle, wherein the edge chamfer 34 forms a cathetus. The running in ribs 22 have a radial rib height H with which they protrude above the bush surface 20.

In a suitable dimensioning, the brush 6 has, for example, a radial length of approximately 8.8 cm and an axial height of approximately 4.2 cm and a tangential width of approximately 3.25 cm, wherein the radius of curvature RE is dimensioned to be 5.6 cm±0.5 cm, for example. In this case, the running in ribs 22 have, for example, a rib height H of approximately 0.16 cm.

In the course of the bedding in procedure of the brush 6, the running in geometry of the brush contact surface 20, which is formed by the running in ribs 22, ensures that the brush 6 has an increasing contact or load-bearing region as the running in process continues, until the axial surface outer edges 24 of the brush 6 are also load-bearing and a running in gap between the brush surface 20 and the commutator surface 18 is consequently reduced to zero (0).

The invention is not restricted to the exemplary embodiments described above. Instead, other variants of the invention can also be derived therefrom by a person skilled in the art without deviating from the subject matter of the invention. In particular, all individual features described in connection with the exemplary embodiments can also be combined with one another in another manner without deviating from the subject matter of the invention.

The following is a summary list of reference numerals and the corresponding structure used in the above description of the invention:
2 Electric motor
4 Commutator
6 Brush
8 Tubular holder
10 Brush pressure spring
12 Tubular-holder base
14 Connection cable
16 Longitudinal slot
18 Commutator surface
20 Brush surface
22 Running in ribs
24 Surface outer edge
26 Surface outer edge
28 Contact point
30 Cable end
32 Cable end
34 Edge chamfer
A Axial direction
R Radial direction
T Tangential direction
RK Radius of curvature/commutator radius
RE Radius of curvature/running in radius
α Angle of inclination
β Chamfer angle
H Rib height

1. An electric motor, comprising:
a commutator having a convex commutator surface; and
at least one brush with a concavely curved brush surface as a running surface for said commutator, wherein said at least one brush having two parallel running in ribs, protruding perpendicularly above said concavely curved brush surface, wherein said running in ribs each having a radius of curvature being greater than a radius of curvature of said convex commutator surface, wherein said running in ribs disposed eccentrically and at a spacing from one another such that they are offset with respect to two opposing surface outer edges of said concavely curved brush surface, and wherein said running in ribs disposed such that they are inclined at an angle of inclination with respect to said two opposing surface outer edges.

2. The electric motor according to claim 1, wherein said running in ribs extend substantially over an entire width of said concavely curved brush surface.

3. The electric motor according to claim 1, wherein the angle of inclination is an acute angle.

4. The electric motor according to claim 3, wherein the angle of inclination is dimensioned such that it is in an angular range between 2° and 10°.

5. The electric motor according to claim 1, wherein said running in ribs have a triangular cross-sectional form.

6. The electric motor according to claim 3, wherein the angle of inclination is dimensioned such that it is in an angular range between 4° and 6°.

7. A brush for an electric motor, comprising:
a concavely curved brush surface having two protruding running in ribs and two opposing surface outer edges, said running in ribs being parallel to one another, wherein said running in ribs disposed eccentrically and at a spacing from one another such that said two running in ribs are offset with respect to said two opposing surface outer edges of said concavely curved brush surface, and wherein said running in ribs being disposed such that said running in ribs being inclined at an angle of inclination with respect to said two opposing surface outer edges.

8. The brush according to claim 7, wherein the brush is a carbon brush.
